(19) United States
(12) Patent Application Publication
(10) Pub. No.: US 2004/0162924 A1
(43) Pub. Date: Aug. 19, 2004

(54) Apparatus and method for transmitting data by means of direct memory access medium

(75) Inventors: Moon-Kee Chung, Moson-si (KR); Jung-Ho Park, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 10/759,232

(22) Filed: Jan. 20, 2004

(30) Foreign Application Priority Data
Jan. 17, 2003 (KR) 2003-3335

(51) Int. Cl. G06F 13/28

(52) U.S. Cl. 710/22

(57) ABSTRACT

An apparatus and method for transferring data stored in a memory to another memory, and an apparatus and method for shifting data by the specified number of bits at a time of transferring data and transferring the shifted data to another memory. The conventional direct memory access (DMA) device sequentially stores data from the first area of a memory address when the data is read from the first memory and the read data is stored in the second memory. Values are set in a control register of the DMA device so that the data is shifted by the specified number of bits at a time of transferring data and the shifted data is transferred in accordance with the described method. Specified data is shifted according to a predetermined value set in the control register and the shifted data is transferred to another memory.

### PRIORITY

This application claims priority to an application entitled “APPARATUS AND METHOD FOR TRANSMITTING DATA BY MEANS OF DIRECT MEMORY ACCESS MEDIUM”, filed in the Korean Intellectual Property Office on Jan. 17, 2003 and assigned Serial No. 2003-3335, the contents of which are hereby incorporated by reference.

### BACKGROUND OF THE INVENTION

1. Field of the Invention

The present invention relates to an apparatus and method for storing data, and more particularly to an apparatus and method for transferring data stored in a specified memory to another storage area.

2. Description of the Related Art

Conventionally, data is transferred in response to a command from a CPU (Central Processing Unit). The CPU is a device for controlling an overall system. The CPU controls a set of operations of processing data received from various input units and outputting a result of the processing to an output unit. When the CPU receives and processes data from the input units, a significant load is placed on the CPU. To reduce the CPU load, part of the CPU functions can be performed by another process. According to the need, a DMA (Direct Memory Access) process has been developed.

As an example of an auxiliary CPU function, the DMA process performs the function of reading data stored in a specified memory or storage area and transferring the read data to another memory or another storage area. When the CPU transfers small amounts of data from the specified memory to another memory, a significant load does not occur on the CPU. However, if large amounts of data or an amount of data greater than a predetermined data size is transferred from the specified memory to another memory in response to the CPU's command, a significant load is placed on the CPU. When the larger amounts of data are transferred, the data transmission rate associated with the DMA process becomes higher than that associated with the CPU. Typically, the predetermined data size is approximately 512 bytes.

FIG. 1 is a block diagram illustrating a system using the conventional DMA. In FIG. 1, an advanced micro-controller bus architecture (AMBA) produced by Advanced RISC Machines (ARM) Ltd. is shown. The AMBA includes an advanced high-performance bus (AHB) operating at a high frequency and an advanced peripheral bus (APB) operating at a low frequency An AHB-APB bridge 108 is coupled between the AHB and the APB so that a high-speed bus and a low-speed bus can exchange data. Referring to the remaining system elements shown in FIG. 1, an AHB block includes a central processing unit (CPU) 100, a first storage unit 102, a DMA device 104 and a bus arbiter 106. The APB block includes a second storage unit 110 and an input/output (I/O) ( ) unit 112. The I/O unit 112 includes a universal serial bus (JSB), a keypad, a universal asynchronous receiver/transmitter (UART), among other items. In order for data stored in the first storage unit 102 to be transferred to the second storage unit 110, all operations are controlled and processed by the CPU 100. When the data stored in the first storage unit 102 is transferred to the second storage unit 110, the CPU 100 reads the data stored in the first storage unit 102. The CPU 100 performs a necessary operation before the read data is transferred to the second storage unit 110. However, when a large amount of data is transferred from the first storage unit 102 to the second storage unit 110, it is difficult for the CPU 100 to appropriately perform a set of operations. There is a problem in that the CPU 100 must perform many tasks associated with the system other than data transmission operations. To address this problem, the DMA device 104 has been developed.

FIG. 1 shows a single DMA device 104. Of course, a plurality of DMA devices can be configured according to the system. The DMA device 104 can transfer the data stored in the AHB block to the APB block or can transfer data stored in the APB block to the AHB block. In this case, the AHB block and the APB block include a plurality of storage units. The DMA device 104 transfers the data stored in the first storage unit 102 to the second storage unit 110 in response to a control command issued by the CPU 100 or an external control command. Data transmission operations performed by the DMA device 104 will be described in greater detail with reference to FIG. 3.

FIG. 2 is a block diagram illustrating the internal structure of the DMA device 104 shown in FIG. 1. As shown in FIG. 2, the DMA device 104 includes a control register, an source address register (SAR)), a destination address register (DAR), a transfer count register (TCR) ( ), a first-in-first-out (FIFO) buffer, a bus controller, an interface, among other items. The SAR is a register for designating an initial source address where data is read from the first storage unit 102. The DAR is a register for designating an initial destination address where the DMA device 104 first writes the data read from the first storage unit 102 to the second storage unit 110. The TCR is a register for designating the number of writing operations when the DMA device 104 writes the data read from the first storage unit 102 to the second storage unit 110. Further, the control register performs a control operation according to a determination as to whether an address value associated with a reading operation must be incremented, decremented or fixed when data is read in a source address of the first storage device 102 and then the next data is read. Furthermore, the control register performs a control operation according to a determination as to whether an address value associated with a writing operation must be incremented, decremented or fixed when data is written in a destination address of the first storage device 102 and then the next data is written. When data is transferred from the first storage unit 102 to the second storage unit 110, the control register performs a control operation for a unit of data capable of being transmitted at once. A unit of data capable of being transmitted at once can be either one byte (8 bits), one half-word (16 bits), one word (32 bits) or some other definable value. Values registered in the registers are associated with commands from the CPU 100 or commands from an external controller.

If register values located within the DMA device are set as described above, data is read from the first storage unit 102 shown in FIG. 1 and written to the second storage unit 110.

The DMA device 104 performs only the function of transferring data stored in the first storage unit to the second storage unit. However, a request can be made so that data having another form different from a form of data stored in the first storage unit is stored in the second storage unit. For example, a request can be made so that data stored in the first storage unit is shifted by the predetermined number of bits, and the shifted data must be stored in the second storage unit. In this case, the DMA device conventionally performs only a control operation for transferring data without carrying out a bit shift operation for data, and the CPU conventionally shifts the transferred data by the predetermined number of bits. Without using the DMA device, the CPU shifts data by the predetermined number of bits and transfers the shifted data to another storage unit. As described above, a transmission rate in the case were the CPU shifts the data by the specified number of bits, and transfers the shifted data to another storage unit is lower than that in the case where the DMA device transfers the data. The DMA device performs part of the CPU functions so that the CPU load is reduced. However, there is a problem in that the CPU load cannot be reduced since the CPU directly performs an operation of shifting data by the specified number of bits. Thus, a new method for shifting the data by the specified number of bits and transferring the shifted data irrespective of the CPU is required.

### SUMMARY OF THE INVENTION

Therefore, the embodiments of present invention has been made in view of the above problems, and it is one object of the present invention to provide an apparatus and method capable of transmitting data shifted by the specified number of bits irrespective of a CPU when the data is transferred from the first storage unit to the second storage unit.

It is another object of the present invention to provide an apparatus and method capable of reducing a delay in processing time occurring when a conventional CPU shifts data by the specified number of bits, and the shifted data is transferred.

To accomplish the above and other objects of the present invention, a new apparatus is proposed. In the new apparatus, register values are set within a control register of a DMA device to decide the specified number of bits to be shifted and a shift direction. If the register values are completely set, data is read from the first storage unit and the read data is stored in a temporary storage unit of the DMA device. After the data stored in the temporary storage unit of the DMA device is read, the read data is shifted on the basis of the set number of bits and the shift direction and the shifted data is stored in the second storage unit.

To accomplish the above and other objects of the present invention, a new method is proposed. In the new method, register values are set within a control register of a DMA device to decide the specified number of bits to be shifted and a shift direction. If the register values are completely set, data is read from the first storage unit and the read data is stored in a temporary storage unit of the DMA device. After the data stored in the temporary storage unit of the DMA device is read, the read data is shifted on the basis of the set number of bits and the shift direction and the shifted data is stored in the second storage unit.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram illustrating a conventional advanced micro-controller bus architecture;

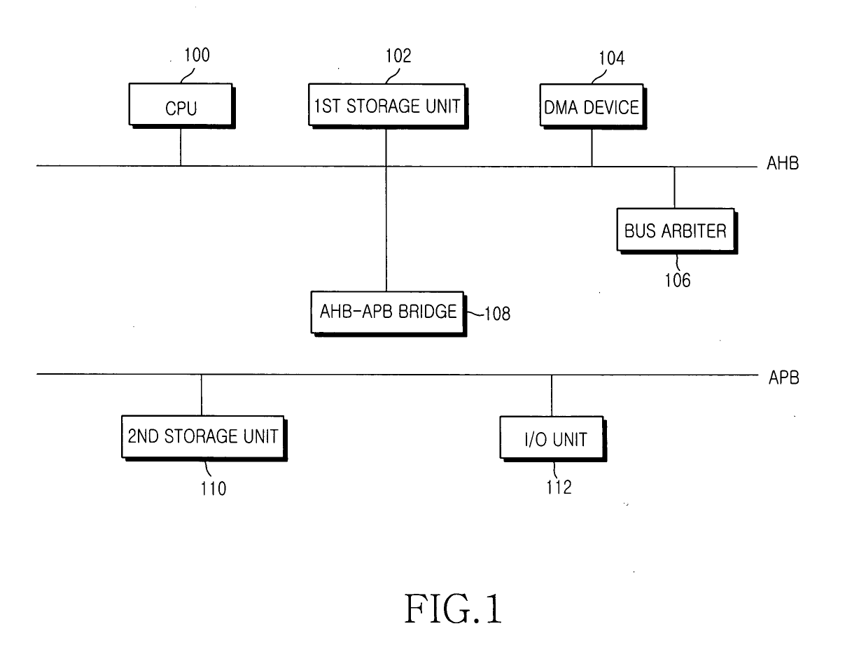

FIG. 2 is a block diagram illustrating the structure of a conventional direct memory access device;

FIG. 3 is a view illustrating an Endian conversion operation that is applied to an embodiment of the present invention;

FIG. 4 is a view illustrating an operation of performing a bit shift operation at a time of transferring data that is applied to an embodiment of the present invention;

FIG. 5 is a flow chart illustrating a procedure of setting register values of a control register for the DMA device that is applied to an embodiment of the present invention;

FIG. 6 is a view illustrating a procedure for transferring data from the first storage unit to the second storage unit in accordance with an embodiment of the present invention; and

FIG. 7 is a view illustrating a procedure for shifting data by means of a protocol layer in accordance with an embodiment of the present invention.

### DETAILED DESCRIPTION OF THE PREFERRED EMBODIMENTS

Certain preferred embodiments of the present invention will now be described in detail with reference to the annexed drawings. In the following description, a detailed description of known functions and configurations incorporated herein will be omitted when it may make the subject matter of the present invention rather unclear.

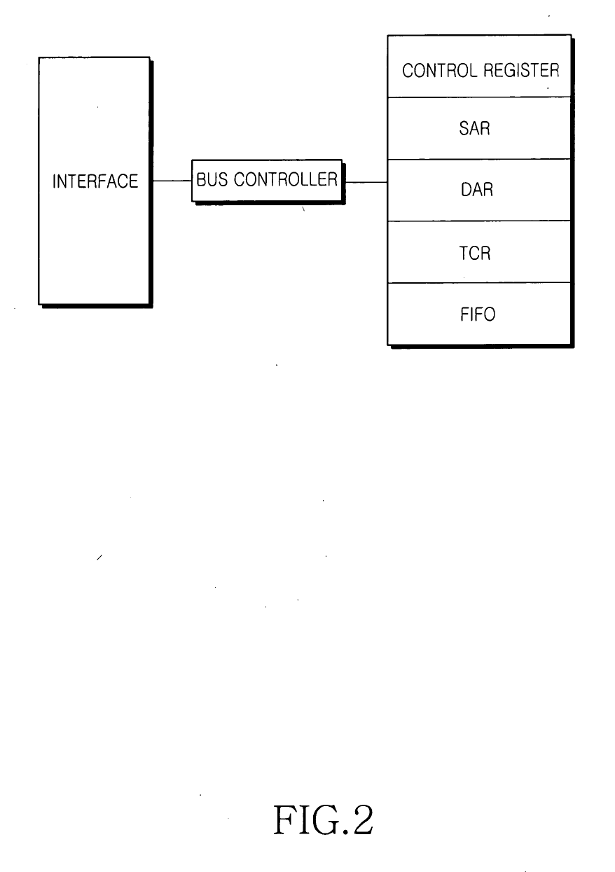

As described above in the “Description of the Related Art” section, FIG. 2 shows a configuration of the conventional DMA device. Values of the SAR, the DAR, the TCR, and other registers, are designated by the CPU 100 or an external control device. However, a specified value, as well as the values of the SAR, the DAR, the TCR, and other registers is designated to shift data by the specified number of bits at the time of transferring the data in accordance with an embodiment of the present invention. The DMA device according to an embodiment of the present invention needs additional information to process data to be transferred. The DMA device conventionally requires information necessary for processing the data along with information necessary for transferring the processed data. The necessary information items are shown in the following Table 1. Elements of the control register and their roles that are applied to an embodiment of the present invention will be described in detail with reference to the following Table 1.

TABLE 1
Control register

| Bit | | | |
|---|---|---|---|
| number | Bit name | Role | Function |
| 11 to 13 | Shift counter | Decision to set | Shift counter: 0 to 7 |
| | | number of | |
| | | bits to be shifted | |
| 10 | Shift direction | Decision to set shift | 0: Right shift |
| | | direction | 1: Left shift |
| 9 | Shift enable | Decision to set bit shift | 0: Shift operation |
| | | operation | 1: Non-shift |
| | | | operation |
| 8 | Endian | Decision to set Endian | 0: Non-Endian |
| | | conversion operation | conversion operation |
| | | | 1: Endian conversion |
| | | | operation |
| 7 | Destination | Decision to set | 0: Increment |
| | address | destination | 1: Decrement |
| | | address | |
| | direction | increment/decrement | |
| | | operation | |
| 6 | Source | Decision to set source | 0: Increment |
| | address | address | 1: Decrement |
| | direction | increment/decrement | |
| | | operation | |
| 5 | Destination | Decision to set | 0: Increment or |
| | address fix | destination | decrement |
| | | address fix | 1: Fix |
| 4 | Source | Decision to set source | 0: Increment or |
| | address fix | address fix | decrement |
| | | | 1: Fix |
| 2 and 3 | Transmission | Decision to set unit of | 00: 8 bits |
| | data size | transmission bits | 01: 16 bits |
| | | | 10: 32 bits |
| 1 | DMA mode | Decision to set | 0: S/W |
| | | DMA mode | 1: H/W |
| 0 | DMA | Decision toset DMA | 0: Non-DMA |
| | activation | activation | operation |
| | | | 1: DMA operation |

As shown above in Table 1, the control register consists of 14 bits. The function column defines the function for each bit location, and how the function operates in relation to the bit value. The functions of the control register proposed in an embodiment of the present invention will be described with reference to the above Table 1. Values of each bit can be arbitrarily adjusted in response to a user's selection. The bit 0 of the control register indicates whether the DMA device 104 must transfer data. If a value of the bit 0 is “0”, the DMA device 104 does not transfer the data. On the other hand, if a value of the bit 0 is “1”, the DMA device 104 transfers the data. The CPU 100 performs the data transmission operation when the amount of data is small, and the DMA device 104 performs the data transmission operation when the amount of data is large. If the value of bit 0 is “1”, bit 1 of the control register is checked.

Bit 1 of the control register indicates an operating mode of the DMA device 104. The operating mode of the DMA device 104 indicates whether an operation of the DMA device 104 is performed by hardware (H/W) or software (S/W). Where the operation of the DMA device 104 is performed by the S/W, the DMA device 104 performs the data transmission operation in response to a control command from the CPU 100. Where the operation of the DMA device 104 is performed by the H/W, the DMA device 104 performs the data transmission operation in response to a control command from an external control system. If the value of bit 1 is “0”, the operation of the DMA device 104 is performed by the S/W. On the other hand, if the value of bit 1 is “1”, the operation of the DMA device 104 is performed by the HIW. Bits 2 and 3 indicate the transmission data size. Bits 2 and 3 indicate a unit of data bits capable of being transmitted at once. If the value of bits 2 and 3 is “00”, the data transmission operation is performed in a unit of 8 bits (one byte). If the value of bits 2 and 3 is “01”, the data transmission operation is performed in a unit of 16 bits (one half-word). Furthermore, if the value of bits 2 and 3 is “10”, the data transmission operation is performed in a unit of 32 bits (one word).

Bit 4 of the control register indicates whether or not a source address fix (SAF) is designated. Bit 4 of the control register defines a source address of the next data to be read, after the data stored in an address designated by the SAR shown in FIG. 2 is read. According to the value of bit 4, a determination is made as to whether a source-address value of the next data to be read must be incremented/decremented, or whether data stored in the same source address must be repeatedly read. If the value of bit 4 is “0”, the source-address value of the next data to be read is incremented/decremented. On the other hand, if a value of the bit 4 is “1”, the next data is read in the same address as a previous source address in which the data has been previously read. Bit 5 of the control register indicates whether or not a destination address fix (DAF) is designated. Bit 5 of the control register defines the next destination address of the next read data to be stored after data read in the source address is stored in a destination address designated by the DAR shown in FIG. 2. According to the value of bit 5 of the control register, a determination is made as to whether a value of the destination address in which the next read data is stored must be incremented/decremented, or whether the next read data must be repeatedly written in the same destination address. If the value of bit 5 is “0”, the next read data is stored after the destination address value for the next read data is incremented/decremented. If, however, the value of bit 5 is “1”, the next read data is written in the same destination address as the previous destination address in which the data has been previously written.

If the value of bit 4 is “0”, bit 6 of the control register is checked. Bit 6 of the control register is a source address direction (SAD) bit indicating whether a source address value must be incremented or decremented. If the source address value of data to be read must be incremented, the value of bit 6 is “0”. Alternatively, if the source address value of data to be read must be decremented, the value of bit 6 is “1”. If the value of bit 5 is “0”, bit 7 of the control register is checked. Bit 7 of the control register is a destination address direction bit (DAD), indicating whether a destination address value must be incremented or decremented. Then, if the destination address value of read data to be written must be incremented, the value of bit 7 is “0”. On the other hand, if the destination address value of the read data to be written must be decremented, the value of bit 7 is “1”.

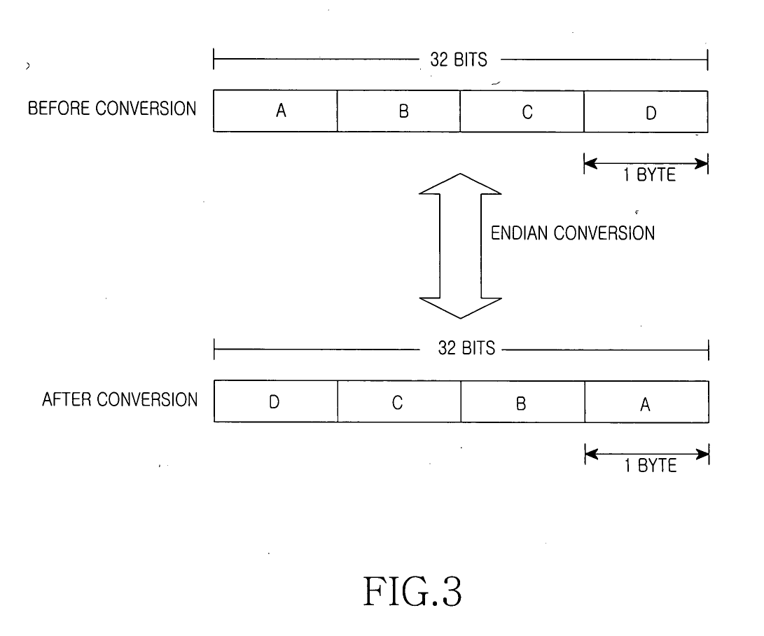

Bit 8 of the control register indicates whether an Endian conversion operation must be carried out. The Endian conversion operation is used only when a unit of transmission bits is set to 32 bits (one word) by bits 2 and 3 of the control register. FIG. 3 explains the Endian conversion operation. In FIG. 3, the transmission bit unit is 32 bits (one word). One word consists of 4 bytes. The 4 bytes are designated A, B, C and D bytes. The first most significant byte is the A byte. The second most significant byte is the B byte. The least significant byte is the D byte. If the Endian conversion operation is performed, the significance of each of the bytes is changed. The most significant byte is converted into the least significant byte, and the least significant byte is converted into the most significant byte. If the value of bit 8 of the control register is “0”, the Endian conversion operation is not carried out. Alternatively, if the value of bit 8 of the controller is “1”, the Endian conversion operation is carried out.

Bit 9 of the control register indicates whether a bit shift operation must be carried out in accordance with an embodiment of the present invention. The bit shift operation is carried out in relation to the FIFO buffer located inside the DMA device. Data read in a source address of the first storage unit is temporarily stored in the FIFO buffer. The data stored in the FIFO buffer is transferred to the second storage unit. In this case, the data shift operation is carried out. If the value of bit 9 of the control register is “0”, the bit shift operation is not carried out. Alternatively, if the value of bit 9 of the control register is “1”, the bit shift operation is carried out. When the bit shift operation is carried out according to the value of bit 9, a shift direction is selected according to the value of bit 10 of the control register. If the value of bit 10 of the control register is “0”, the bit shift operation is carried out in the right direction. Alternatively, if the value of bit 10 of the control register is “1”, the bit shift operation is carried out in the left direction.

When the bit shift operation is carried out according to the value of bit 9, the value of bits 11 through 13 of the control register are checked. The value of bits 11 through 13 of the control register defines the number of bits to be shifted. The number of bits that can be shifted ranges from 0 and 7. When the number of bits is “0”, the bit shift operation is not carried out. Table 2 corresponds to the case when the data of bits 0 to 7 are read in a source address (indicating the address “01”) when the bit shift direction is right, and then the read data is stored in destination addresses (indicating the addresses “41” and “42”). It is assumed that the transmission data size is 8 bits, and the data read in the address “01” is sequentially stored in the addresses “41” and “42” as shown in Table 2.

TABLE 2

| | Bit number | Bit number | | Bit number |
|---|---|---|---|---|
| Number | of read data | of data | Bit number of | of data to be |
| of shift | (source | to be stored | read data | stored |
| bits | address “01”) | (address “41”) | (address “01”) | (address 42”) |
| 0 | Bits 0 to 7 | Bits 0 to 7 | | |
| 1 | Bits 0 to 6 | Bits 1 to7 | Bit 7 | Bit 0 |
| 2 | Bits 0 to 5 | Bits 2 to 7 | Bit 6 and 7 | Bits 0 and 1 |
| 3 | Bits 0 to 4 | Bits 3 to 7 | Bits 5 to 7 | Bits 0 to 2 |
| 4 | Bits 0 to 3 | Bits 4 to 7 | Bits 4 to 7 | Bits 0 to 3 |
| 5 | Bits 0 to 2 | Bits 5 to 7 | Bits 3 to 7 | Bits 0 to 4 |
| 6 | Bits 0 and 1 | Bits 6 and 7 | Bits 2 to 7 | Bits 0 to 5 |
| 7 | Bit 0 | Bit 7 | Bits 1 to 7 | Bits 0 to 6 |

Table 3 corresponds to the case where data of bits 0 to 7 are read in a source address (indicating the address “01”) when the bit shift direction is left and then the read data is stored in the destination addresses (being the addresses “40” and “41”). It is assumed that he transmission data size is 8 bits, and read data is stored in the address “41” as shown in Table 3, when the bit shift operation for the data read in the address “01” is not carried out.

TABLE 3

| | | | | Bit number |
|---|---|---|---|---|
| | Bit number of | Bit number of | Bit number of | of data to be |
| Number | read data | data to be | read data | stored |
| of shift | (source address | stored (address | (address | (address |
| bits | “01”) | “40”) | “01”) | “41”) |
| 0 | | | Bits 0 to 7 | Bits 0 to 7 |
| 1 | Bit 0 | Bit 7 | Bits 1 to7 | Bits 0 to 6 |
| 2 | Bits 0 and 1 | Bits 6 and 7 | Bit 2 and 7 | Bits 0 to 5 |
| 3 | Bits 0 to 2 | Bits 4 to 7 | Bits 3 to 7 | Bits 0 to 4 |
| 4 | Bits 0 to 3 | Bits 3 to 7 | Bits 4 to 7 | Bits 0 to 3 |
| 5 | Bits 0 to 4 | Bits 2 to 7 | Bits 5 to 7 | Bits 0 to 2 |
| 6 | Bits 0 to 5 | Bits 1 and 7 | Bits 6 and 7 | Bits 0 and 1 |
| 7 | Bits 0 to 6 | Bits 6 and 7 | Bit 7 | Bit 0 |

Table 4 illustrates the relationship between hexadecimal data 0-E and its binary equivalent.

TABLE 4

| Data | Binary value | Data | Binary value |
|---|---|---|---|
| 0 | 0000 | 8 | 1000 |
| 1 | 0001 | 9 | 1001 |
| 2 | 0010 | A | 1010 |
| 3 | 0011 | B | 1011 |
| 4 | 0100 | C | 1100 |
| 5 | 0101 | D | 1101 |
| 6 | 0110 | E | 1110 |
| 7 | 0111 | F | 1111 |

Tables 5 to 8 explain the process for reading data in a source address, performing a bit shift operation, and writing the data corresponding to the result of the bit shift operation in a destination address. Table 5 corresponds to the case where the transmission but unit is 8 bits (when the value of the bits 2 and 3 of the control register is “00”) and the values of bits 4 to 10 of the control register are “0”, respectively. Regarding Table 5, the value of bits 11 and 13 of the control register indicates that the number of bits to be shifted is 4. Furthermore, 8-bit data is stored in each address, but the user can arbitrarily set the number of bits to be stored other than the 8-bit data.

TABLE 5

| | | Destination | |
|---|---|---|---|
| Source address | Data | address | Data |
| 00 | 1 2 | 40 | U 1 |
| 01 | 3 4 | 41 | 2 3 |
| 02 | 5 6 | 42 | 4 5 |
| 03 | 7 8 | 43 | 6 7 |
| 04 | 9 A | 44 | 8 9 |
| 05 | B C | 45 | A B |
| 06 | D E | 46 | C D |
| 07 | F 1 | 47 | E F |
| 08 | 2 3 | 48 | 1 2 |
| 09 | 4 5 | 49 | 3 4 |

As described above, data stored in the source address and data stored in the destination address are each 8 bits. Two data items (8 bits) are stored in the source address or destination address. As described above regarding Table 4, one data value consists of 4 bits. When data items of “1” and “2” stored in the source address “00” are stored in the destination addresses, the data items are shifted by 4 bits in the right direction and the shifted data items are stored in the destination addresses. Thus, the data of “1” stored in the source address “00” is written to the destination address “40”. In this case, the data of “1” stored in the source address is written as back-end data consisting of 4 bits in the address “40”. Furthermore, the data of “2” stored in the source address “00” is shifted by 4 bits, and then the shifted data is written in the destination address 41. In this case, the data of “2” is written as front-end data consisting of 4 bits in the destination address “41”. The 4 bits of the front-end data in the destination address “40” is filled with an arbitrary value. Data items of “3” and “4” stored in the source address are written as the back-end data in the destination address “41” and the front-end data in the destination address “42”, respectively. As shown above in Table 5, data values stored in the source addresses are transferred and written in the destination addresses.

Table 6 corresponds to the case when the transmission bit unit is 32 bits (when the value of bits 2 and 3 of the control register are “10”), and the values of bits 4 to 10 of the control register are “0”, respectively. In relation to Table 6, the values of bits 11 and 13 of the control register indicate that the number of bits to be shifted is 4. Furthermore, although an 8-bit data is stored in each address, the user can arbitrarily set the number of bits to be stored to be other than the 8-bit data.

TABLE 6

| Source address | Data | Destination address | Data |
|---|---|---|---|
| 00 to 03 | 7 8 5 6 3 4 1 | 40 to 43 | 6 7 4 5 2 3 U |
| 04 to 07 | F 1 D E B C 9 | 44 to 47 | E F C D A B 8 |
| 08 to 09 | X X X X 4 5 2 | 48 to 49 | U U U U U U 1 |

As shown in Table 6, data stored in a set of source addresses and data stored in a set of destination addresses are 32 bits each. Eight data items are stored in the set of source addresses and the set of destination addresses. As shown in Table 4, one data value consists of 4 bits. Since the transmission bit unit is 32 bits in relation to Table 6, data capable of being read at once is data stored in the four addresses. Further, the data items of “1” and “2” are stored in the source address “00”. The data items of “3” and “4” are stored in the source address “01”, as in Table 5. Data values stored in the remaining source addresses are the same as in Table 5. Data items read in the source addresses “00” to “03” are shifted by 4 bits, respectively, and the shifted data items are written in the destination addresses “40” to “44”. Data values stored in the destination addresses “40” to “49” are the same as in Table 5.

Table 7 corresponds to the case where the transmission bit unit is 8 bits (when the value of bits 2 and 3 of the control register is “00”), and values of bits 4 to 9 of the control register are “0”, respectively. In relation to Table 7, the value of bit 10 of the control register is “1” and the value of bits 11 and 13 of the control register indicate that the number of bits to be shifted is 4. Furthermore, although 8-bit data is stored in each address, the user can arbitrarily set the number of bits to be stored to be other than the 8-bit data.

TABLE 7

| Source address | Data | Destination address | Data |
|---|---|---|---|
| 00 | 1 2 | 40 | 2 3 |
| 01 | 3 4 | 41 | 4 5 |
| 02 | 5 6 | 42 | 6 7 |
| 03 | 7 8 | 43 | 8 9 |
| 04 | 9 A | 44 | A B |
| 05 | B C | 45 | C D |
| 06 | D E | 46 | E F |
| 07 | F 1 | 47 | 1 2 |
| 08 | 2 3 | 48 | 3 4 |
| 09 | 4 5 | 49 | 5 U |

As shown in Table 7, data stored in the source address and data stored in the destination address are 8 bits each. Two data items (8 bits) are stored in the source address or destination address. As shown in Table 4, one data value consists of 4 bits. Where the data items of “1” and “2” stored in the source address “00” are stored in the destination address, the data items are shifted by 4 bits, respectively, and the shifted data items are stored in the destination addresses. Thus, the data of “1” stored in the source address “00” is not written in the destination address. The data of “2” stored in the source address “00” is written as front-end data in the address “40”. As the data of “3” stored in the source address “01” is shifted in the left direction, the shifted data is written as back-end data in the destination address “40”. As this operation is carried out, data values stored in the source addressed are written in the destination addresses as shown in Table 7.

Table 8 corresponds to the case where the transmission bit unit is 32 bits (when the value of bits 2 and 3 of the control register is “00”), and the values of bits 4 to 9 of the control register are “0”. In relation to Table 8, the value of bit 10 of the control register is “0” and the value of bits 11 and 13 of the control register indicate that the number of bits to be shifted is 4. Furthermore, although 8-bit data is stored in each address, the user can arbitrarily set the number of bits to be stored to be other than the 8-bit data.

TABLE 8

| Source address | Data | Destination address | Data |
|---|---|---|---|
| 00 to 03 | 7 8 5 6 3 4 1 | 40 to 43 | 8 9 6 7 4 5 2 |
| 04 to 07 | F 1 D E B C 9 | 44 to 47 | 1 2 E F C D A |
| 08 to 09 | X X X X 4 5 2 | 48 to 49 | U U U U U 5 3 |

As shown in Table 8, data stored in a set of source addresses and data stored in a set of destination addresses are 32 bits each. Eight data items are stored in the set of source addresses and the set of destination addresses. As shown in Table 4, one data value consists of 4 bits. Since the transmission bit unit is 32 bits, in relation to Table 8, data capable of being read at once is stored in the four addresses. Further, the data items of “1” and “2” are stored in the source address “00” and the data items of “3” and “4” are stored in the source address “01” as in Table 5. Data values stored in the remaining source addresses are the same as in Table 5. Data items read in the source addresses “00” to “03” are shifted by 4 bits in the right direction, respectively, and the shifted data items are written in the destination addresses “40” to “44”. Data values stored in the destination addresses “40” to “49” are the same as in Table 7.

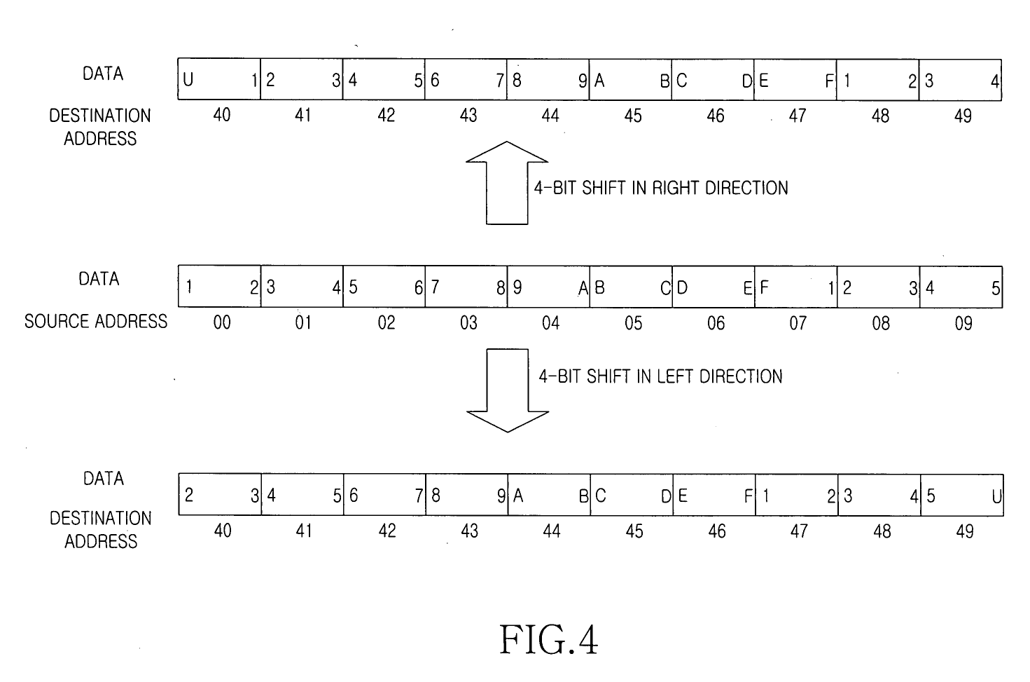

FIG. 4 is a view illustrating an operation of performing a bit shift operation at a time of transferring data that is applied to an embodiment of the present invention. FIG. 4 shows the contents of both destination and source addresses described in relation to Tables 5 and 8. As shown in FIG. 4, data items stored in the source address are shifted by 4 bits, and the shifted data items are written as a destination address. Data items of the source addresses shown at the middle of FIG. 4 are shifted by 4 bits in the right direction and the shifted data items are written in the destination addresses shown at the top of FIG. 4. Furthermore, the data items of the source addresses shown at the middle of FIG. 4 are shifted by 4 bits in the left direction and the shifted data items are written in the destination addresses shown at the bottom of FIG. 4.

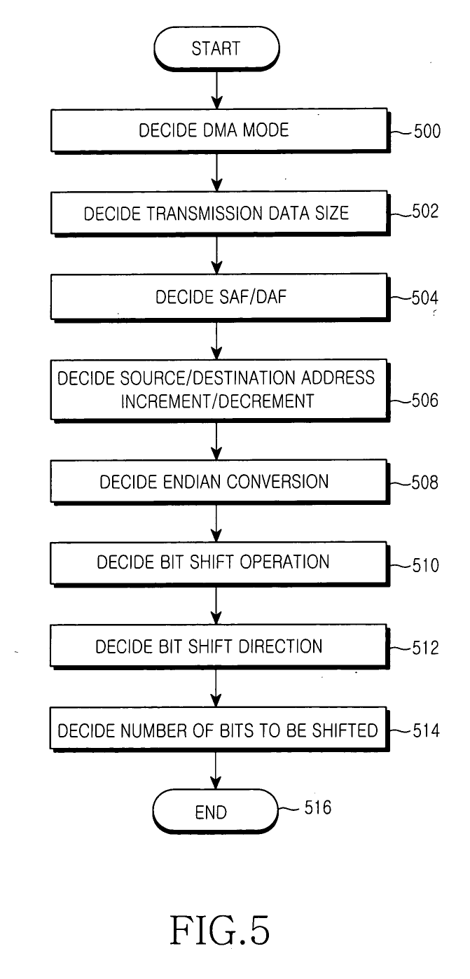

FIG. 5 is a flow chart illustrating a procedure for setting register values of the control register for the DMA device that is applied to an embodiment of the present invention. In the control register setting procedure, a DMA mode is set in response to a control command at step 500. The DMA mode includes a hardware mode and a software mode as described above. The transmission data size is set in response to the control command at step 502 of the control register setting procedure. In response to the control command, a determination is made as to whether or not the SAF/DAF is designated at step 504 of the control register setting procedure. The SAF/DAF indicates whether data must be repeatedly read in the same address or whether data must be repeatedly written in the same address.

When it is determined that data must be read and written in another source/destination address at step 504, a determination is made as to whether an address value associated with the reading/writing operation must be incremented or decremented at step 506 of the control register setting procedure. Then, it is determined whether an Endian conversion operation must be carried out at step 508 of the control register setting procedure. At step 510 of the control register setting procedure, it is determined whether a bit shift operation must be carried out. If it is determined that the bit shift operation must be carried out at the above step 510, a bit shift direction and the number of bits to be shifted are decided at steps 512 and 514. Each of the above steps 500 to 514 can be divided into several steps, but these are typically performed as one step. As shown in FIG. 5, if bit values of the control register are set and the DMA device 104 is driven according to the value of bit 0 of the control register, the data transmission operation is performed.

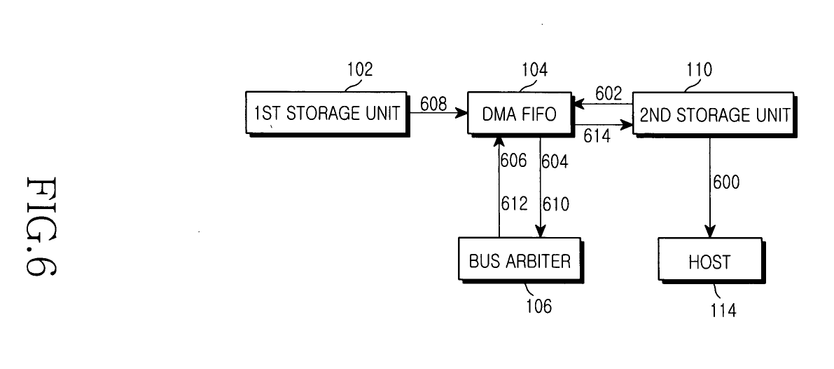

FIG. 6 is a view illustrating a procedure for transferring data from the first storage unit to the second storage unit in accordance with an embodiment of the present invention. FIG. 6 shows a procedure for reading data stored in the first storage unit 102 and writing the read data to the second storage unit 110 when the bit values of the control register are set as shown in FIG. 5. Before the data transmission operation is performed, register values associated with the SAR, the DAR, the TCR, and the other registers shown in FIG. 2 must be set. If the register values associated with the SAR, the DAR, the TCR, and the other registers shown in FIG. 2 are set, the data transmission operation is performed. Referring to the configuration shown in FIG. 6, the configuration includes a first storage unit 102, a DMA device 104, a second storage unit 110, a bus arbiter 106 and a host 114. An operation of transferring data stored in the first storage unit 102 to the second storage unit 110 will be described with reference to FIG. 6. At step 600, the host 114 reads data stored in the second storage unit 110. Thus, if a memory of the second storage unit 110 is emptied out by the host 114, the memory emptied out by the host 114 is filled with data read from the first storage unit 104. At step 602, the second storage unit 110 requests the DMA device 104 to provide data so that the empty memory can be filled. In response to the request from the second storage unit 110, the DMA device 104 requests the bus arbiter 106 to give it a right to access the bus necessary for performing data communication with the first storage unit 102. The bus can be used by one device at a time, and the bus arbiter 106 allows the bus to be used in a predetermined order if multiple requests for bus use are received from a plurality of devices. A single DMA device 104 is shown in FIG. 6, but a plurality of DMA devices can be included. Any one of the plurality of DMA devices can make requests for bus use. Accordingly, the bus arbiter 106 allows the DMA devices to use the bus in predetermined order.

In response to the request from the DMA device 104, the bus arbiter 106 provides the bus to be used at step 606. The DMA device 104 reads data stored in the first storage unit 102 by means of the provided bus at step 608. The read data is present within the DMA device 104 and stored in an arbitrary FIFO memory. An address of data to be read from the first storage unit 102 is set by the SAR arranged within the DMA device 104 as shown in FIG. 2. If the data stored in the first storage unit 102 is read and then the read data is stored in the FIFO buffer, the DMA device 104 requests the bus arbiter 106 to provide a bus necessary for data communication with the second storage unit 110 at step 610. Steps 610 and 612 are the same as the steps 604 and 606. If the bus arbiter 106 allows the DMA device 104 to use the bus, the DMA device 104 transfers the data stored in the FIFO buffer to the second storage unit 110. An address of the read data to be stored is set by the DAR as shown in FIG. 2.

The DMA device 104 transfers data stored in the first storage unit 102 to the second storage unit 110 by repeatedly performing the above steps 600 to 614. The number of repeats is set by the TCR as shown in FIG. 2. If the data transmission operation is performed on the basis of the number of repeats set by the TCR, the CPU or external control device is notified that the data transmission operation is completed.

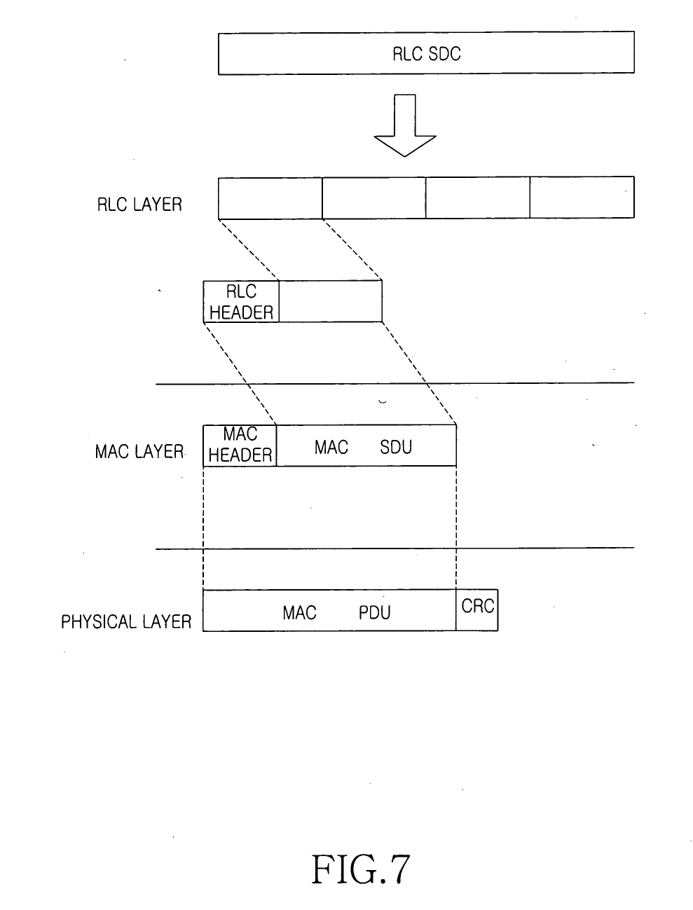

FIG. 7 is a view illustrating a procedure for shifting data by means of a protocol layer in accordance with an embodiment of the present invention. FIG. 7 shows a data transmission operation performed by an radio link control (RLC) layer or a medium access control (MAC) layer. When the RLC layer or the MAC layer desires to attach a header to data, data is shifted by the number of bits corresponding to the header and the shifted data is transmitted. When the bit shift operation is performed by the DMA device rather than the CPU in accordance with an embodiment of the present invention, the processing rate can be enhanced. Table 9 shows the results of a comparison between the data processing rate associated with the CPU and the data processing rate associated with the DMA device.

TABLE 9

| | | | Processing | |
|---|---|---|---|---|
| | | Processing | by CPU + | Processing by |
| Data size | Cache | by CPU | DMA device | DMA device |
| 1 k × 16 bits | Driving | 872.2 | 1028 | 242.4 |
| | Non-driving | 8576.2 | 8836 | 269.2 |

Although the preferred embodiments of the present invention have been disclosed for illustrative purposes, those skilled in the art will appreciate that various modifications, additions and substitutions are possible, without departing from the scope of the invention. Therefore, the present invention is not limited to the above-described embodiments and drawings.

What is claimed is:

1. A method for reading and storing data by means of a direct memory access (DMA) medium, comprising the steps of:
deciding a shift direction and a predetermined number of bits to be shifted in advance when a request is made so that data read from a first storage medium can be processed; and
sequentially storing bit strings configuring the read data in a register, shifting the bit strings by the predetermined number of bits in the decided shift direction, and transferring the shifted bit strings to a second storage medium.

2. The method as set forth in claim 1, wherein each of the bit strings configuring the read data is configured by one of an 8-bit string, a 16-bit string or a 32-bit string.

3. The method as set forth in claim 2, wherein the number of bits to be shifted has a value of from 0 to 7.

4. The method as set forth in claim 3, wherein the step of deciding the shift direction and the number of bits to be shifted depends upon bit values set by the DMA medium.

5. The method as set forth in claim 1, further comprising the steps of:
classifying the bit strings configuring the read data into more significant bit strings and less significant bit strings; and
rearranging positions of less and more significant bit strings and writing the read data to the second storage medium according to a result of the rearrangement.

6. The method as set forth in claim 5, wherein the read data is configured in the form of 32 bits at the step of rearranging the positions of the less and more significant bit strings.

7. The method as set forth in claim 6, wherein the step of rearranging the positions of the less and more significant bit strings depends upon bit values set by the DMA medium.

8. An apparatus for reading and storing data by means of a direct memory access (DMA) medium, comprising:
a first storage medium for storing data read in a source address;
the DMA medium for deciding a shift direction and a predetermined number of bits to be shifted in advance when a request is made so that the read data can be processed, sequentially storing bit strings configuring the read data in a register, shifting the bit strings by the predetermined number of bits in the decided shift direction, and transferring the shifted bit strings; and
a second storage medium for storing data transferred from the DMA medium.

9. The apparatus as set forth in claim 8, wherein the DMA medium reads each of the bit strings configuring the read data with one of an 8-bit string, a 16-bit string or a 32-bit string.

10. The apparatus as set forth in claim 9, wherein the DMA medium carries out a shift operation according to the number of bits to be shifted that has a value of from 0 to 7.

11. The apparatus as set forth in claim 10, wherein the DMA medium decides the shift direction and the number of bits to be shifted according to set bit values.

12. The apparatus as set forth in claim 8, wherein the DMA medium classifies the bit strings configuring the read data into more significant bit strings and less significant bit strings, rearranges positions of less and more significant bit strings, and writes the read data to the second storage medium according to a result of the rearrangement.

13. The apparatus as set forth in claim 12, wherein the DMA medium rearranges the positions of the less and more significant bit strings when the read data is configured in the form of 32 bits.

14. The apparatus as set forth in claim 13, wherein DMA medium rearranges the positions of the less and more significant bit strings according to set bit values.
